(19) United States
(12) Patent Application Publication
(10) Pub. No.: US 2016/0292797 A1
(43) Pub. Date: Oct. 6, 2016

(54) METHOD AND SYSTEM FOR FACILITATING PLACEMENT OF AN ORDER

(71) Applicant: Eric S. Tucker, Lee's Summit, MO (US)

(72) Inventor: Eric S. Tucker, Lee's Summit, MO (US)

(21) Appl. No.: 15/087,749

(22) Filed: Mar. 31, 2016

Related U.S. Application Data
(60) Provisional application No. 62/140,665, filed on Mar. 31, 2015.

(51) Int. Cl. G06Q 50/12; G06F 17/30; G10L 15/26; G06Q 30/06

(52) U.S. Cl. CPC G06Q 50/12; G06Q 30/0635; G06F 17/30569; G10L 15/26

(57) ABSTRACT

A method and system for facilitating anonymous placement of an order at a restaurant is disclosed. The method may include receiving one or more messages from a user device. The message may include the order. Additionally, in some instances, the message may be transformed into a structured order. Further, the method may include presenting one or more codes to a user and receiving the one or more codes from the user. Moreover, the method may include presenting the order to the user on the user device. Additionally, the method may include performing one or more actions on the one or more messages based on receipt of each of the one or more codes and confirmation of the order from the user.

### FIELD OF INVENTION

The present disclosure generally relates to communication using personal devices. More specifically, the disclosure relates to systems and methods for facilitating anonymous users to place orders using a personal device such as a mobile phone.

### BACKGROUND OF INVENTION

People often travel by car and use restaurants to eat on the go, rarely going inside the restaurant and instead using the drive through. However, the drive through can be burdensome to use sometimes, but a necessary evil when on the go, and food or drink is required. The conventional drive through may be based on two-way voice communication, where the order may be taken using a customer dialog. The two-way voice dialog may result in unavoidable miscommunication, through human error or equipment malfunction, which may significantly reduce the speed of service and customer satisfaction.

Certain drive through systems use handheld devices for ordering but are given to servers and employees of the restaurant. The handheld devices are not used by customers. Furthermore, certain restaurants provide an internet web portal and mobile phone applications for online food ordering by providing a list of restaurants within a particular location. However, placing orders at the drive through using one's mobile phone has challenges. Firstly, people may not want a stranger to have their mobile phone number; secondly, drive through may face difficulties in maintaining and prioritizing the orders. Further, the existing processes are cumbersome and require additional hardware and software components for placing orders.

Therefore, the current solutions require investment of time, resource and money by calling for installing additional software applications or specific hardware components to the user's personal device. Moreover, current solutions do not protect the privacy of a customer while placing an order.

As a result, there exists a need for systems and methods for facilitating placement of an order at a restaurant that enhance quality, efficiency, and customers' satisfaction by providing an order in advance, and removing human error in the order-taking and order-delivery process.

### SUMMARY OF INVENTION

It is an object of the present disclosure to provide a method and system of communication that allows users in a drive through to anonymously place orders using a personal device. Further, it is an object to facilitate order placement using the personal device's built in apps and services without requiring a user of the personal device to install additional software.

One embodiment of the present application describes a method of facilitating anonymous placement of an order at a restaurant. The method may include receiving at least one message from a user device. The message may include the order. Additionally, in an instance, the message may be transformed into a structured order. Further, the method may include presenting at least one code to a user and receiving the at least one code from the user. Furthermore, the method may include presenting the order to the user on the user device. Additionally, the method may include performing at least one action on the at least one message based on receipt of each of the at least one code and confirmation of the order from the user.

Another embodiment of the application describes a system for facilitating anonymous placement of an order at a restaurant. The system may include a communication unit configured to communicate with a user device associated with a user and a processor communicatively coupled to the communication unit. The processor may be configured to receive at least one message from the user device. The at least one message may include the order. Additionally, in an instance, the processor may be configured to transform the message into a structured order. Further, the processor may be configured to present at least one code to the user and receive the at least one code from the user. Moreover, the processor may be configured to present the order to the user on the user device. Further, the processor may perform at least one action on the at least one message based on receipt of each of the at least one code and confirmation of the order from the user. In an instance, the at least one action may include forwarding of the at least one message to an order-taker device.

Certain embodiments of the disclosure may provide various technical advantages. For example, certain implementations may provide greater security and privacy to the user maintaining anonymity of the user than do present communication and ordering systems. As embodiments of the claimed invention do not require any special applications on the user's personal device, users may conveniently place orders without the hassle of installing an additional mobile app. Standard features of a personal device such as SMS, email or standard web browser may facilitate the desired functionality. Additionally, since the system mediates communication of the order from the user to an order-taker, personal information of the user may be kept private maintaining complete anonymity of the user. Further, the system may be designed to work without using an NFC (Near Field Communication) like Bluetooth or GPS type service to determine location in drive through lane.

The system may advantageously improve user satisfaction and speed of service by reducing miscommunication and transmitting order information between the user and the order-taker.

In some embodiments, the system may provide an electronic wallet based payment option reducing the order completion time by minimizing the time of the transaction taking place at the drive-through window.

These and other advantages, features, and objects of the claimed application will become apparent upon review of the following detailed description of the preferred embodiments when taken in conjunction with the drawings and the appended claims.

### BRIEF DESCRIPTION OF DRAWINGS

Exemplary embodiments of the present invention are described hereinafter with reference to the following drawings.

FIG. 1 is a schematic representation of a system configured to facilitate placement of an order in accordance with some embodiments.

FIG. 2 is a flow chart illustrating an exemplary method for facilitating placement of an order in accordance with some embodiments.

FIG. 3 illustrates a flow chart of a method of facilitating anonymous placement of order in a drive-through in accordance with some embodiments.

FIG. 4 illustrates a flow chart of a method of facilitating anonymous placement of order in a restaurant in accordance with some embodiments.

FIG. 5 illustrates a layout view of a drive-through depicting position of presentation devices for presenting one or more codes in accordance with some embodiments.

While embodiments of the present disclosure are amendable to various modifications and alternative forms, specific embodiments are shown by way of example in the drawings and are described in detail. It should be understood, however, that the drawings and detailed description thereto are not intended to limit the present disclosure to the particular form disclosed, but on the contrary, the intention is to cover all modifications, equivalents, and alternatives falling within the spirit and scope of the present disclosure as defined by the appended claims.

### DETAILED DESCRIPTION OF INVENTION

The following detailed description is made with reference to the figures. Embodiments are described to illustrate the disclosed system and method, not to limit their scope.

### Overview

Embodiments of the present application are directed to systems and methods for facilitating placement of an order at a restaurant.

Embodiments of the present application relate to methods and systems of communication that allow users to anonymously place orders in a drive through using a personal device such as a mobile phone. The user may use the built in apps and services of the personal device to communicate by SMS, email, or internet, whichever is available on the personal device. The user may not be required to download and/or install any additional program on the personal device. The user may initiate communication by sending a message to a system implemented as a “store and forward” system via Short Messaging Service (SMS), email or internet. The system may hold the message based on predetermined rules until certain codes or phrases are received by the user from the system and/or a store system/POS/order-taker and then entered into the user's personal device and sent back to the system and/or the store system/POS/order-taker.

The user, at key points in the communication and/or key locations in the drive-through lane, may send a message including a code or phrase known by the system to cause an action on the stored message. Based on the receipt of the code and in some instances confirmation of the order from the user, the system may perform actions on the message including forwarding the message to the store system/POS/order-taker, cleaning/modifying messages before forwarding, or replying to the user. On forwarding the message to the store system/POS/order-taker, the system may not display phone number or personal information of the user to the store system/POS/order-taker. Additionally, the store and forward system, based on predetermined rules, may select parts of the messages that are relayed back and forth between the store system/POS/order-taker and the user. For instance, before a message is forwarded, the message may go through a cleanup process to remove any unwanted language or unnecessary words to facilitate the order transaction and provide a clean structured order for entry to the store's systems. Furthermore, the system may reply to the user with predetermined messages to clarify information or confirm the order.

In some embodiments, the user may not be registered or known by the system or store system/POS/order-taker. However, the system may store a plurality of information about the store system/POS/order-taker's business. Further, a direct communication link may not be established between the user and store system/POS/order-taker. The system may determine how and when parts or all of the messages can proceed based on the user's visual cues received from and returned to the system demonstrating the user may be in the drive through and/or at a point of final ordering such as an intercom or an order station.

The visual cues, the codes, or the phrases may be on displays located along the drive-through lane at predetermined spots which may give the system the location of the user in the drive through lane. These codes or phrases may be displayed on a sign or on a digital display. They may be fixed codes or may be dynamically displayed and controlled by the system or the store system/POS/order-taker. Further, embodiments of the claimed invention provide that there may be one code but may also be optimally two. One code may be displayed as they enter the drive through lane and the other code at the intercom. The code at the intercom may be required at a minimum. The visual displays may get the code or phrase from the “store and forward” system or the store system/POS/order-taker. The code may be unique to that store for duration of time predetermined by the business and/or the “store and forward” system. The code may be re-used by the “store and forward” system at another time and possibly with another store if using dynamic phrases.

### Exemplary Systems

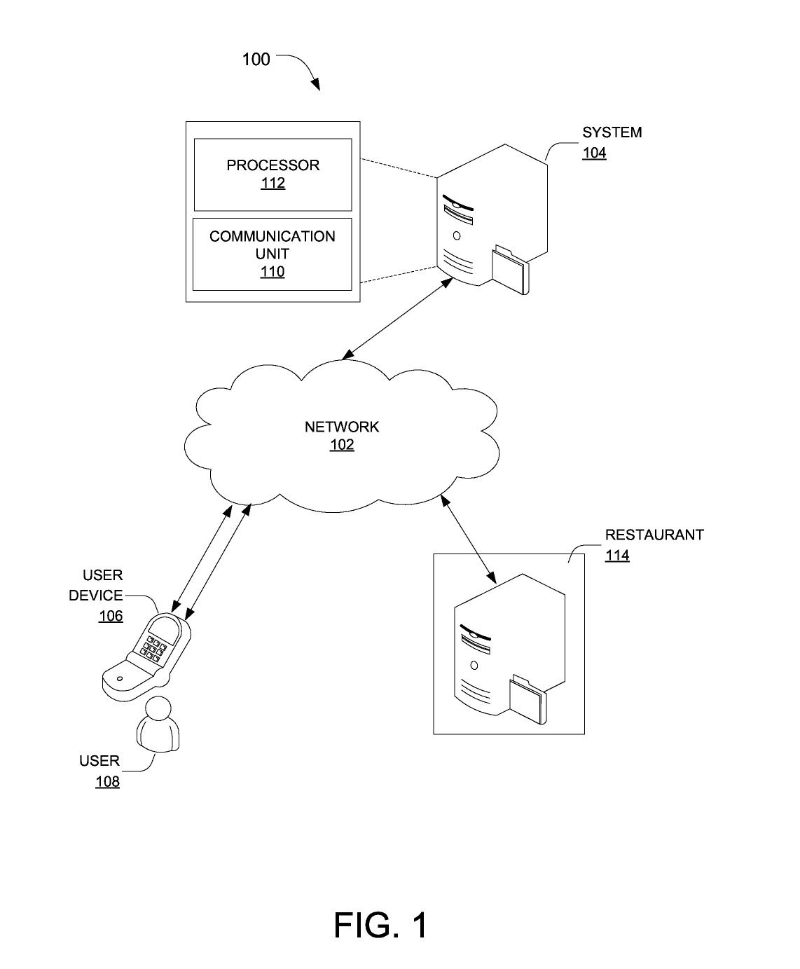

FIG. 1 illustrates an exemplary environment 100 in which the subject matter of the disclosure can function. The environment 100 generally includes a network 102 communicatively coupling a system 104 to one or more user devices 106. Users 108 may operate user devices 106 to place an order from a restaurant 114 using the system 104. Additionally, the network 102 communicatively couples the system 104 to the restaurant 114 which may include an order-taker device. The user 108 may initiate an order request with the system 104 using any of the one or more user devices 106.

The network 102 generally refers to any interconnecting system capable of transmitting audio, video, signals, data, messages, or any combination of the preceding. Further, the network 102 may include all, or a portions of a public switched telephone network (PSTN), a public or private network, a local area network (LAN), a metropolitan area network (MAN), a wide area network (WAN), a local, regional, or global communication or computer network such as the Internet, a wired or wireless network, an enterprise intranet, other suitable communication link, or any combination of similar systems.

The system 104, in some embodiments, may be a store and forward message server for receiving and catering to order requests from the user 108 and/or the restaurant 114. The system 104 may include, for example, a web server, a computer workstation, or any other device operable to dynamically receive message comprising order requests from the user device 106 and facilitate placement of the order at the restaurant 114. Further, the system 104 may use any appropriate operating system, such as MS-DOS®, MAC-OS®, WINDOWS®, UNIX®, including operating systems developed hereafter.

As used here, the term user device 106 generally refers any suitable device operable to communicate with the system 104 and the restaurant 114 through the network 102. Accordingly, the restaurant 114 may include a server computer configured to communicate through the network 102. Further, the user device 106 may employ any known operating systems such as MS-DOS®, PC-DOS®, OS-2®, MAC-OS®, or any other appropriate operating systems. The user device 106 may include, for example, a personal digital assistant, a computer (e.g., a laptop, a desktop workstation, a server, etc.), a cellular phone, a mobile internet device (MID), an ultra-mobile PC (UMPC), or any other device operable to communicate with the system 104 through the network 102.

The user device 106 may include a user interface for interacting with the system 104 and placing order requests. Using the user interface, the user 108 may select a specific restaurant 114 along a destination route. The user device 106 may also include a user input device that allows the user 108 to interact with the user device 106. The user input device may take a variety of forms, such as a touch-screen, button, keypad, dial, etc. Further, the user device 106 may include a display screen to display information to the user.

The system 104 may include a communication unit 110, a processor 112, and in some embodiments, storage (not shown in figure). The communication unit 110 may be communicatively coupled to the processor 112 and may be configured to communicate with the user device 106 associated with the user 108. The communication unit 110 may connect the system 104 to the network 102 for receiving order requests from the user device 106 and servicing the order requests in cooperation with the restaurant 114.

The communication unit 110 may refer to any suitable device capable of receiving a message and/or sending a message from the system 104. For example, the communication unit may include appropriate hardware modem, network interface card, and similar devices. Further, the software capabilities of the communication unit 110 may include protocol conversion and data processing capabilities, to communicate through a LAN, WAN, or other communication system, allowing the system 104 to communicate to other devices. Moreover, the communication unit 110 may include one or more ports, conversion software, or both.

The processor 112 can be any suitable device capable of executing instructions and manipulating data to perform operations for the system 104. The processor 112 may be utilized for processing requirements of the system 104. Processor 112 may include microprocessors, microcomputers, microcontrollers, digital signal processors, central processing units, state machines, logic circuitries, and/or any devices that manipulate signals based on operational instructions. For example, processor 112 may be any central processing unit (CPU), such as such as the Pentium processor, the Intel Centrino processor, and so on.

The storage may be divided into one or more program(s) and data. The data includes various data banks for storing different data. The programs store various program modules designed to dynamically receive and cater to order requests made by user 108 corresponding to the restaurant 114. For example, the storage may store restaurants located in a geographic area and the corresponding menu including the items offered by the restaurant. The storage may also include information on other businesses located on a highway and the nearby areas. Further, the storage may be any suitable device capable of storing computer-readable data and instructions. For example, the storage may include logic in the form of software applications, random access memory (RAM) or read only memory (ROM). Further examples may include mass storage medium (e.g., a magnetic drive, a disk drive, or optical disk), removable storage medium (e.g., a Compact Disk (CD), a Digital Video Disk (DVD), or flash memory), a database and/or network storage (e.g., a server), other computer-readable medium, or a combination of any of the preceding.

The restaurant 114 may be a drive-through business allowing customers to purchase products without leaving their automobile vehicle. The restaurant 114 may include a microphone, CCTV camera, a carhop, drive lanes, and the like for the user 108 to provide the code and pick up the food item. The restaurant 114 may execute the requested order, provided by the system 104. The restaurant 114 may also provide an access control for verifying the user 108 and delivering correct orders.

In operation, the user 108 may initiate an order request using a standard messaging application on the user device 106. To this end, the user 108 may use the user device 106 to send an order request to the system 104. Accordingly, the system 104 may receive a message from the user device 106 corresponding to the order request. The message may include the order to be placed with the restaurant 114.

In some embodiments, the user 108 may send the message to the system 104 using a Short Messaging Service (SMS), an e-mail, or an internet based message. For instance, the user 108 may type an SMS, including the order, from the user device 106 and send to the system 104.

In another embodiment, the user 108 may use message service from Facebook Messenger, WhatsApp, Google Hangout, Apple iMessage, Skype, Twitter and the like. The system 104 may be configured to receive messages and recognize order requests from such internet based message services.

On receiving the message, the system 104 may transmit one or more codes to the user 108 using the communication unit 110. Accordingly, the processor 112 may be configured to present the one or more codes to the user 108. In some embodiments, the one or more codes may be unique to the restaurant 114 until the one or more codes are received from the user 108.

Further, in some embodiments, the user 108 may be presented the one or more codes at a location of the restaurant. The location information may include one or more of a drive through lane, an intercom station, an interior of the restaurant and an order station.

For instance, in some embodiments, when the user 108 is at a predetermined location in a drive through lane, the one or more codes may be presented to the user 108. The predetermined location may be proximal to the intercom station. Alternatively, in some embodiments, the system 104 may present the one or more codes to the user 108 on one or more of the user device 106 and a presentation device associated with the restaurant 114.

In some embodiments, the system 104 may determine the location of the user 108 based on the one or more codes received from the user 108. As the one or more codes may be specific to the user 108 at a specific location, the processor 112 may determine the time for order pickup. Based on the order pickup time, the system 104 may communicate the time to the restaurant 114. On receiving the time, the restaurant 114 may prepare the order accordingly to keep the order fresh.

In some embodiments, the user 108 may specify a particular time to pick up the ordered items. At the particular time, the user 108 can directly go to the restaurant 114 without wasting time waiting for an order or after an order has lost its freshness.

For instance, the one or more codes may be visual cues or phrases that may be displayed on displays located along the drive-through lane at predetermined spots. The one or more codes at predetermined spots give the system 104 the location of the user 108 in the drive through lane. Further, the one or more codes may be displayed on a sign or on a digital display. In some instances, the one or more codes may be fixed codes. Alternatively, the one or more codes may be dynamically displayed and controlled by the system 104 and/or the order-taker. The one or more codes may be unique for a duration of time predetermined by the system 104.

Further, the user 108 may transmit the one or more codes to the system 104. The communication unit 110 of the system 104 may receive the transmitted one or more codes and communicate to the processor 112 for further processing. In some embodiments, the system 104 may receive the one or more codes from the user device 106. In another embodiment, the user 108 may transmit the one or more codes using a second user device 106.

In some embodiments, a messaging application pre-installed on the user device 106 may facilitate the transmission of the one or more codes. It will be understood by a person skilled in the art that a pre-install of the application may not be required by the user 108 for transmitting the one or more codes. The messaging application may be pre-installed by the user 108, a manufacturer of the user device 106, a service provider of wireless communication and the like. For example, the user 108 may use a commonly used internet based message service such as Facebook Messenger, WhatsApp, Google Hangout, Apple iMessage, Skype, Twitter and the like to transmit the code. The user 108 may utilize the hash-tag (#) and @ symbols to transmit the code intended for the system 104. The system 104 may be configured to receive and recognize the one or more codes from such internet based message services.

In some embodiments, the user 108 may transmit a speech input including the one or more codes to the communication unit 110. For instance, the one or more codes may be displayed to the user 108 at an intercom station and the user 108 may speak the one or more codes. In another embodiment, the user 108 may receive the one or more codes on the user device 106 and may then speak the one or more codes into the intercom station.

Based on the receipt of the one or more codes, the processor 112 may perform at least one action on the message. Additionally, in some embodiments, the at least one action may be performed further based on receipt of confirmation of the order from the user. In some embodiments, the system 104 may not perform an action on the message prior to the arrival of the one or more codes to safeguard the system 104 from cyber attacks and cyber bots. For instance, the system 104 may be flooded with order requests from computer bots and hackers which may try to fool the system 104. As an example, to prevent the system 104 from catering to false order requests and distinguish between humans and computers, the system 104 may be configured to perform an action on the message of a true order request.

In some embodiments, the processor 112 may forward the message to an order-taker device of the restaurant 114. The processor 112 may determine that the message is an order request from the user 108 and may communicate the message to the communication unit 110. On receiving, the communication unit 110 may forward the message to the order-taker device of the restaurant. In an exemplary embodiment, the processor 112 may forward the message, as it is, without making any changes to the message to the communication unit 110. In another embodiment, the processor 112 may parse the message and recognize the content specifying the order included in the message. On recognizing and identifying the relevant content, the processor 112 may modify the message for easier and faster processing of the order request by the order-taker device of the restaurant 114.

In some embodiments, the processor 112 may filter the message to remove at least one of unwanted language and an unnecessary word. Accordingly, the processor 112 may filter the message and forward the filtered message to the communication unit 110. To this end, the processor 112 may parse the message and recognize the content specifying the order included in the message. On recognizing and identifying the relevant content, the processor 112 may filter the message to remove unwanted language and unnecessary words which may be of no use to the order-taker device of the restaurant 114. Thus, the filtered message may help in faster and accurate processing of the order.

Further, in some embodiments, the processor 112 may transform the message into a structured order based on at least one of text processing and speech processing. For instance, based on the Natural Language Processing (NLP) technique, the processor 112 may transform the message into a structured order. Use of such techniques offer the advantage of taking a speech order from the order station and handling it via a computer system without requiring human employee involvement.

Additionally, in some embodiments, the processor 112 may compare a portion of the message with at least one data element of a menu associated with the restaurant and may generate a structured order based on a result of the comparing. The processor 112 may access the menu associated with the restaurant stored in the storage of the system 104. On accessing, the processor 112 may compare the message with the elements of the menu for a restaurant. The processor 112 may utilize a suitable comparison algorithm for arriving at the result. Based on a result of the comparison, the processor 112 may generate the structured order and communicate the structured order to the communication unit 110. Further, in some embodiments, the communication unit 110 may transmit the structured order to the user device 106 and/or a presentation device associated with the restaurant 114. Accordingly, the user 108 may review the order.

In some embodiments, the processor 112 may perform an action on the message based on at least one predetermined rule. The processor 112 may run a predetermined rule prior to performing an action on the message. The predetermined rule may be stored in the storage of the system 104. The processor 112 may access the predetermined rule from the storage and apply them.

The predetermined rule may be any rule that dictates when and what actions are performed based on the message. In a scenario, a predetermined rule may specify that when the order meets certain predefined criteria, the order may be handled according to a set protocol. For example, the user may be driving on a national highway of a particular state, say California. Then, a predetermined rule may be set specifying that the favorite food of California, such as fish tacos, may be offered with the order as complementary to the user without any additional charges. In another scenario, the predetermined rule prohibiting sale of liquor during specific hours may be set to prevent accidents. Moreover, on specific routes or in specific districts of a state, predetermined rules may prohibit sale of liquor, which have statistically recorded accidents. In another example, when the user may order from a specific restaurant, then predetermined rule may be set for offering specialties of the restaurant on receiving an order above a specific dollar value.

Furthermore, the predetermined rule may be set which may mandate identity of the user 108 in certain geographic locations. Such a rule may be set keeping in view the crime history of the geographic area. Hence, on receiving the user identity and determining that the user 108 is not in the fugitive or terrorist list, an appropriate action may be taken on the message. Thus, the predetermined rule serves an advantageous function of performing an appropriate action on the message based on the situation. The action on the message may be different based on a specific test condition and resulting action specified by the predetermined rule.

In some embodiments, the system 104 may present the order to the user 108 on the user device 106 for confirmation. Accordingly, the user 108 may review the order and provide an input representing confirmation of the order. The confirmation of the order may then be conveyed to the system 104 in the form of a conformation message.

In some embodiments, the restaurant 114 may send purchase information including information such as items ordered, the price, the delivery time, and the like to the user 108. The purchase information may be presented to the user 108 on the user device 106.

In some embodiments, the user 108 may make the payment for the order from the user device 106. The user device 106 may have an associated electronic wallet. The processor 112 may determine that the electronic wallet has sufficient funds to make the payment for the order. If the user 108 does not have sufficient funds, then the system 104 may request the user 108 to credit sufficient funds to the electronic wallet. If the user 108 does not credit sufficient funds, then the order may not be delivered to the user 108. If the electronic wallet is credited with sufficient funds, the order may be delivered to the user 108.

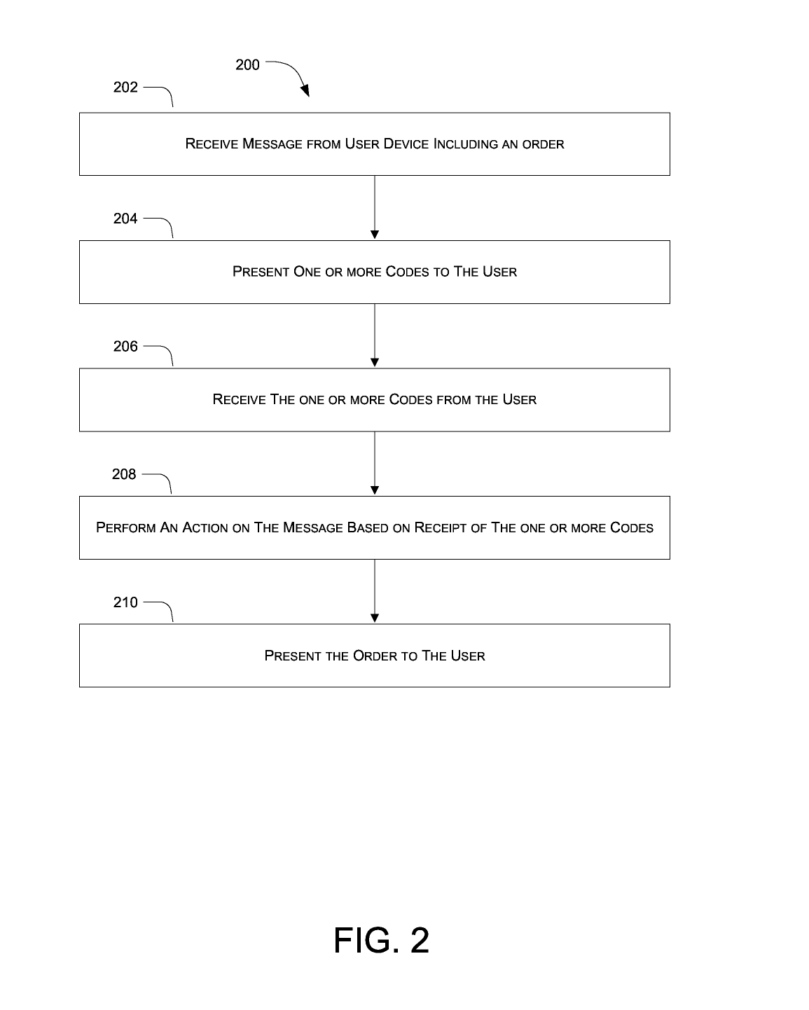

FIG. 2 illustrates an exemplary method 200 for facilitating anonymous placement of an order at the restaurant 114 for the user 108. The exemplary method is described with reference to the environment 100 and the system 104 explained in FIG. 1. These exemplary methods may be described in the general context of computer executable instructions. Generally, computer executable instructions can include routines, programs, objects, and the like that perform particular functions or implement particular abstract data types. The methods may also be practiced in a distributed computing environment where functions are performed by remote processing devices that are linked through a communications network. In a distributed computing environment, computer executable instructions may be located in both local and remote computer storage media, including memory storage devices.

In FIG. 2, the process begins at step 202, where the system 104 may receive a message from the user device 106 corresponding to a request for an order placement. The message may include the order to be placed with the restaurant 114. To this end, the user 108 may use the user device 106 to send an order request to the system 104. The user 108 may initiate the order request using a standard messaging application on the user device 106.

In some embodiments, the user 108 may send the message to the system 104 using a Short Messaging Service (SMS), an e-mail, or an internet based message. For instance, the user 108 may type an SMS, including the order, from the user device 106 and send to the system 104.

In some embodiments, the user 108 may send an internet based message such as a message from Facebook Messenger, WhatsApp, Google Hangout, Apple iMessage, Skype, Twitter, and the like. The system 104 may be configured to receive messages from such internet based message services. Further, the system 104 may be configured to recognize the order request from such message and parse the content of the message.

Additionally, in some embodiments, subsequent to receiving the message, one or more operations may be performed on the message. For instance, a transformation of the message into a structured order may be performed. As an example, the message may be parsed using a language model based parser and subsequently converted into a message according to a predefined format. As another example, in case the message is in the form of speech, speech processing may be performed on the message in order recognize spoke words and subsequently convert the message into a structured order.

Moving to the step 204, the system 104 may present one or more codes to the user 108. In some embodiments, the presenting of the one or more codes may be performed at a location of the restaurant. Accordingly, in some embodiments, the processor 112 may be configured to communicate the one or more codes to a presentation device, such as for example, a display device and/or a speaker, situated at the location. For instance, the location may include one or more of one or more drive through lanes, one or more intercom stations, an interior of the restaurant 114 and one or more order stations of the restaurant 114.

Further, in some embodiments, the one or more codes may be presented when the user is at a predetermined location in the one or more drive through lanes. Furthermore, the predetermined location may be proximal to the intercom station.

Alternatively, in some embodiments, the presenting of the one or more codes may be performed on one or more of the user device 106 and a presentation device associated with the restaurant 114.

In some embodiments, the one or more codes may be unique to the restaurant 114 until the one or more codes are received from the user 108. In some embodiments, the one or more codes may be associated with a user 108 until that user 108 places or completes the order. Subsequently, the one or more codes may be reassigned to another user 108.

In some other embodiments, different codes may be assigned to different users. For example, the one or more codes may be designed with certain characters assigned for the State, the National Highway number, the restaurant 114, menu item, and the like. For example, for California State, State Route 91, XYZ restaurant, and fish tacos, the one or more codes may be CASR91XYZFT. The one or more codes may also be designed as a random number. The one or more codes may be stored in the storage of the system 104 and may be accessed by the processor 112.

At step 206, the system 104 may receive the one or more codes from the user 108. In some embodiments, the user 108 may transmit the one or more codes to the system 104 using the user device 106. In another embodiment, the user 108 may transmit the one or more codes to the system 104 using a different device. For example, the user 108 may transmit the one or more codes from a second computing device present with the user 108. Further, the communication unit 110 may receive the one or more codes and communicate to the processor 112 for further processing.

In some embodiments, the transmission of the one or more codes may be facilitated by a messaging application pre-installed on the user device 106. It will be understood by a person skilled in the art that a pre-install of the application may not be required by the user 108 for transmitting the one or more codes. The messaging application may be either pre-installed by the user 108, a manufacturer of the user device 106, a service provider of wireless communication and the like. For example, the user 108 may use a commonly used internet based message service such as Facebook Messenger, WhatsApp, Google Hangout, Apple iMessage, Skype, Twitter and the like to transmit the one or more codes. The user 108 may utilize the hash-tag (#) and @ symbols to transmit the one or more codes intended for the system 104. The system 104 may be configured to receive the one or more codes from such internet based message services. Further, the system 104 may be configured to parse and recognize the content of the one or more codes.

In some embodiments, the receiving of the one or more codes from the user 108 may include receiving a speech input from the user 108. In other words, the user 108 may provide the speech input including the one or more codes to the system 104. For instance, the one or more codes may be displayed to the user 108 at the intercom station and the user 108 may speak the one or more codes. In another embodiment, the user 108 may receive the one or more codes on the user device 106 and may then speak the one or more codes into the intercom station.

The method 200 continues to step 208 where the system 104 may perform one or more actions on the message based on the receipt of the one or more codes. On receipt of the one or more codes, the processor 112 may be configured to perform one or more actions on the message. Additionally, in some embodiments, the one or more actions may be performed on the message further based on receipt of a confirmation of the order from the user.

However, the step 208 may not preclude actions being performed on the message prior to arrival of the one or more codes. Further, in some embodiments, any processing on the message may not dependent on the receipt of the one or more codes. For instance, the processor 112 may transform the message into a structured order without necessarily depending on receipt of the one or more codes.

In some embodiments, the system 104 may not perform an action on the message prior to the arrival of the one or more codes to safeguard the system 104 from cyber attacks and cyber bots. The system 104 may be flooded with order requests from computer bots and hackers which may try to fool the system 104. To prevent the system 104 from catering to false order requests and distinguish between humans and computers, the system 104 may be configured to perform an action on the message of a true order request.

In some embodiments, the action performed on the message may include forwarding the message to an order-taker device of the restaurant 114. Accordingly, the processor 112 may determine that the message is an order request from the user 108. Further, based on the receipt of the one or more codes from the user 108 as explained in step 206, the processor 112 may communicate the message to the communication unit 110. On receiving, the communication unit 110 may forward the message to the order-taker device of the restaurant. In an exemplary embodiment, the processor 112 may forward the message, as it is, without making any changes to the message to the communication unit 110. In another embodiment, the processor 112 may parse the message and recognize the content specifying the order included in the message. On recognizing and identifying the relevant content, the processor 112 may modify the message for easier and faster processing of the order request by the order-taker device of the restaurant 114.

At step 210, the system 104 may present the order to the user 108 on the user device 106. In some embodiments, the order may be presented to the user 108 at a location of the restaurant 114. The location information may include at least one of a drive through lane, an intercom station, an interior of the restaurant and an order station. Alternatively, in some embodiments, the order may be presented to the user 108 on the user device 106. Accordingly, the user 108 may review the order.

In some embodiments, the processor 112 may perform an action on the message based on one or more predetermined rules. The processor 112 may run a predetermined rule prior to performing an action on the message. Based on the predetermined rule, the processor 112 may perform an action on the message. The action on the message may be different based on a specific test condition and an action of the predetermined rule. The predetermined rule may be stored in the storage of the system 104. The processor 112 may access the predetermined rule from the storage and apply them.

In some embodiments, the processor 112 may be configured to perform filtering the message to remove one or more of unwanted language and an unnecessary word. Accordingly, the processor 112 may be configured to modify the message and forward the modified message to the communication unit 110. The processor 112 may parse the message and recognize the content specifying the order included in the message. On recognizing and identifying the relevant content, the processor 112 may modify the message. Thus, the modified message may help in faster and more accurate processing of the order.

In some embodiments, the processor 112 may transform the message into a structured order based on one or more of text processing and speech processing. For instance, based on a Natural Language Processing (NLP) technique, the processor 112 may transform the message into a structured order.

In another embodiment, the processor 112 may compare a portion of the message with at least one data element of a menu associated with the restaurant. Based on the comparison, the processor 112 may generate a structured order. The processor 112 may access the menu associated with the restaurant stored in the storage of the system 104. On accessing, the processor 112 may compare the message with the elements of the menu for a restaurant. Based on a result of the comparison, the processor 112 may generate the structured order and communicate the structured order to the communication unit 110. The communication unit 110 may then transmit the structured order to the user device 106 and/or a presentation device associated with the restaurant 114.

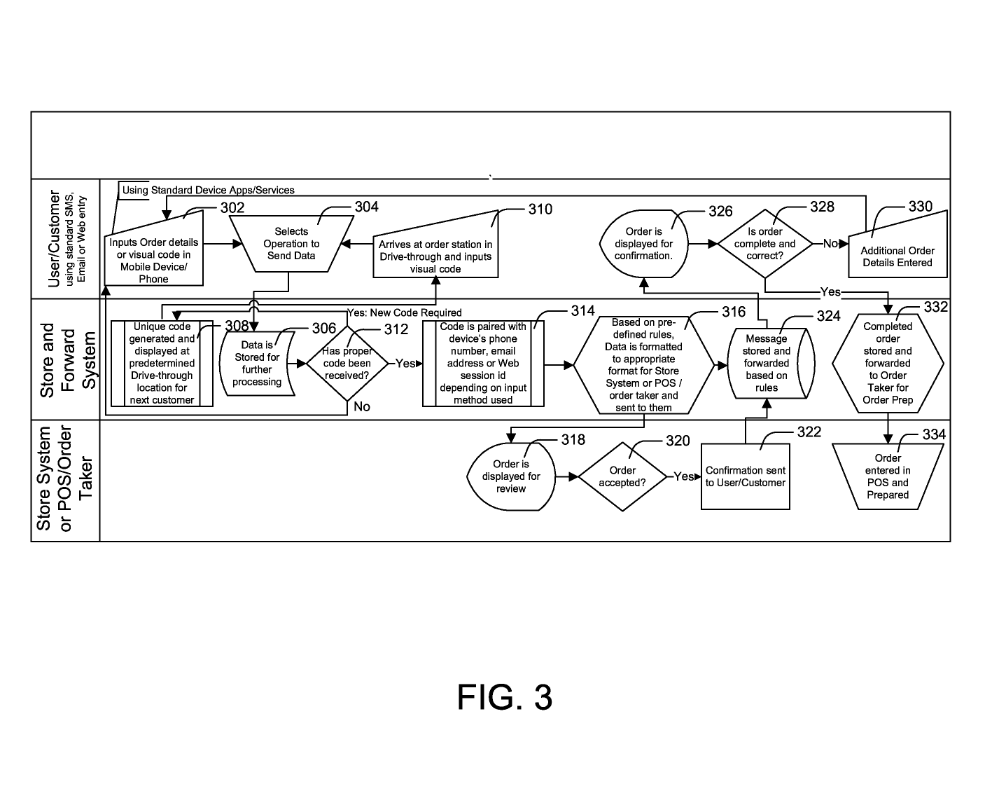

Turning now to FIG. 3, a flow chart of a method for facilitating anonymous placement of an order in a drive-through according to some embodiments is illustrated. The method may begin at step 302 when a customer inputs order details and/or a visual code corresponding to the order in a mobile device such as, for example, a mobile phone. The order details may be input using standard apps and/or services available on the mobile device. For example, the customer may enter the order details through a web interface, SMS, email and/or internet based messaging app such as for example, a social networking app. Accordingly, there may be no need for the customer to install any special app in order to place the order.

Subsequently, at step 304, the customer may select an option to send data including the order details to a system implemented, for example, in the form of a “store and forward” system. Accordingly, at step 306, the “store and forward system” may receive the order details and store them for further processing.

Thereafter, at step 308, a unique code may be generated by the “store and forward” system and displayed at a pre-determined location in the drive-through lane. For example, the predetermined location may be proximal to the order taking station or an intercom station. Accordingly, at step 310, when the customer arrives at the predetermined location, the customer may view the unique code and enter the unique code into the mobile device. Subsequently, step 304 may be carried out to transmit the unique code entered by the customer to the “store and forward” system which may then store the unique code for further processing by performing step 306.

Further, the method may proceed to step 312, where the “store and forward” system checks whether a proper code has been received. If the result of the check is negative, then the method proceeds to step 308 where a unique code is generated and presented to the customer. However, if the result of the check is positive, then at step 314, the unique code received from the customer is paired with one or more of the mobile device's phone number, email address and/or session identifier depending on the input method used by the customer to enter the order details.

Thereafter, at step 316, the order details received from the customer may be suitably formatted based on pre-defined rules and transmitted to the store system/POS/order-taker. For example, the order details may be received from the customer in a natural language form. However, such a form may not be suitable for processing by the “store and forward” system and/or the order-taker. Accordingly, in some embodiments, at step 316, the order details may be parsed by a language model based parser and transformed into a structured order. The structured order may include pre-defined tokens that are known to the “store and forward” system and/or the order-taker. For instance, the structured order may include names of the items in the menu and corresponding quantity. Subsequently, the order may be displayed to the order-taker for review. Thereafter, at step 320 an input from the order-taker may be received corresponding to acceptance or rejection of the order. If the order-taker accepts the order, then at step 322, a confirmation of the order may be transmitted to the customer. Further, in some embodiments, the confirmation may be stored and forwarded to the customer at step 324 based on predetermined rules.

Accordingly, the acceptance of the order may be conveyed to the customer along with order details for confirmation from the customer at step 326. Subsequently, at step 328, the customer may check whether the order is correct and/or complete. In case, a result of the check is negative, then the customer may enter additional order details at step 330. The method may then proceed to step 302 where the additional order details may be entered into the mobile device. Thereafter, the method may proceed to step 304 where the additional order details may be transmitted to the “store and forward” system.

However, if the result of the check at step 328 is positive, the method may proceed to step 322 where the confirmed/completed order may be stored and forwarded to the order-taker for order preparation. Accordingly, at step 334, the order may be entered into a POS terminal and prepared for delivery.

Further, in some embodiments, forwarding of the order to the order-taker may be based on each of receipt of the code from the user and confirmation of the order from the user. Accordingly, it may be ensured that the order is forwarded to the order taker only when the user is at a predetermined location in the drive through lane, such as near the intercom station and has also confirmed the order.

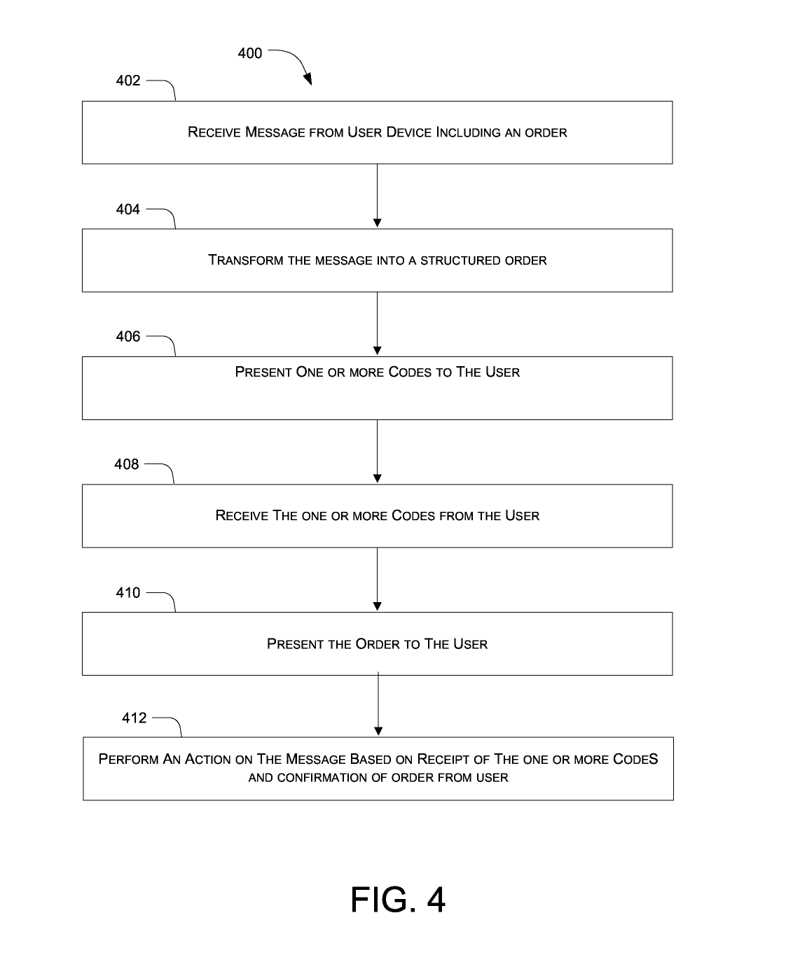

Turning now to FIG. 4, a flowchart of a method 400 for facilitating anonymous placement of order in a restaurant in accordance with some embodiments is illustrated. The method 400 may include a step 402 of receiving the one or more messages from the user device. Further, the one or more messages may include the order. For instance, the user may enter the one or more messages into the user device and send it to the system through one or more communication mode such as, for example, SMS, email and internet based messaging.

Further, at step 404, the method may include transforming the one or more messages into a structured order. As an example, the message may be parsed using a language model based parser and subsequently converted into a modified message according to a predefined format. As another example, in case the message is in the form of speech, speech processing may be performed on the message in order recognize spoke words and subsequently convert the message into a structured order.

Additionally, the method may include a step 406 of presenting the one or more codes to the user. For instance, the one or more codes, unique to the restaurant, may be displayed to the user while the user is near the order station. Accordingly, the user may be able to view the one or more codes.

Further, the method may include a step 408 of receiving the one or more codes from the user. For example, subsequent to viewing the one or more codes, the user may enter the one or more codes at an input device situated at the order station. For instance, the user may speak the one or more codes into an intercom phone at the order station. Alternatively, the user may enter the visual code into a keypad situated at the order station. In some other embodiments, the user may enter the one or more codes into the user device and transmit the one or more codes to the system using a communication mode such as, but not limited to, SMS, email and internet based messaging.

As a result, upon receiving the one or more codes from the user, the system may determine that the user has arrived proximal to the order station.

Additionally, the method may include a step 410 of presenting the order to the user. In an instance, the order may be presented to the user for confirmation. Further, in some embodiments, the presentation may be performed on the user device. Accordingly, the system may be configured to transmit the order to the user device through a communication mode such as, for example, but not limited to, SMS, email and/or internet based messaging. Alternatively, in some other embodiments, the order may be presented to the user on a presentation device situated at the restaurant, such as a location near the intercom station where the user may be present.

Furthermore, the method may include a step 412 of performing one or more actions on the one or more messages based on receipt of each of the one or more codes and confirmation of the order from the user. For example, the one or more actions may include forwarding the message and/or the structured order to the order-taker device. Since the forwarding of the order to the order-taker may be performed based on both receipt of the one or more codes and confirmation of the order, it may be ensured that when the order arrives at the order-taker, the order is complete and also that the user is proximal to the order station and/or an order pickup station. Accordingly, one or more of the user and the order-taker may be provided with an enhanced experience in placing and processing orders at the restaurant.

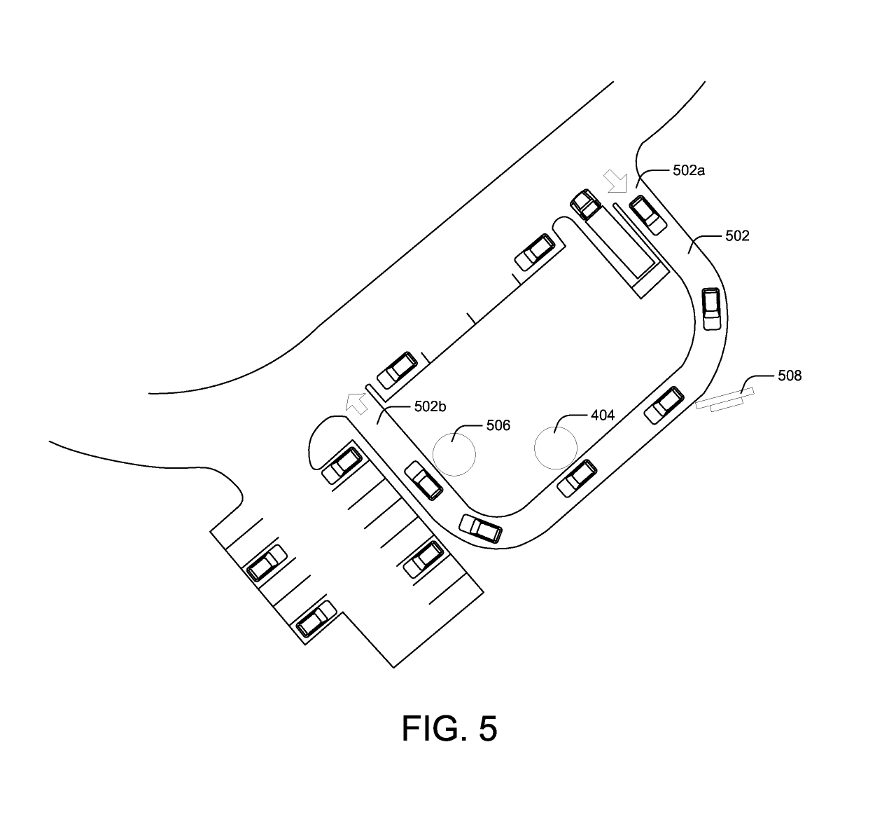

Referring now to FIG. 5, a layout view of a drive-through 500 including a drive-through lane 502. As illustrated, the drive through lane 502 may include an entrance point 502a and an exit point 502b. Further, the drive through lane 502 may be designed to allow vehicles, such as cars, to enter the entrance point 502a and drive along the drive through lane 502 finally exiting through the exit point 502b. In addition, the drive through 500 may include one or more order stations 504 and one or more order pickup stations 506.

In addition, the drive through 500 may include one or more presentation devices 508. A presentation device 508 may in some embodiments be communicatively coupled to the system as described in conjunction with FIG. 1 to FIG. 4 such as, for example, the “store and forward” system. Further, the presentation device 508 may be situated at one or more locations along the drive through lane. For instance, as illustrated the presentation device 508 may be located at a location proximal to the order station 504.

In an exemplary scenario, as a user drives a car into the drive through lane near the entrance point 502a, the user may place an order by entering order details into a mobile device. Subsequently, the mobile device may transmit the order in the form of one or more of a SMS, an email and/or an internet based message to the system, such as the “store and forward” system. Subsequently, the system may generate and display a code on the presentation device 508 such as and LCD/LED screen.

Once the car arrives near the presentation device 508, the user may be able to view the code displayed. Subsequently, the user may enter the code at the order station. Alternatively, the user may speak the code at an intercom phone present at the order station. Once the code is received from the user, the system may determine that the user is at the order station and may accordingly forward the previously stored order details to the order-taker at the order station. As a result, the order-taker may be able to view the order at a time when the user is present at the order station. Additionally, the order-taker may only be able to view order details without any personal information about the user such as the phone number, email address or social network identity. Further, as explained in conjunction with FIG. 3, once the order-taker accepts the order, the order details may be presented to the user for final confirmation after which, the order may be sent for preparation. Subsequently, the user may drive the car to the order pickup station 506 and receive the ordered items.

The invention can be implemented by software, in hardware or a combination of hardware and software. The invention can also be embodied as computer readable code on a computer readable medium. The computer readable medium is any data storage device that can store data which can thereafter be read by a computer system. Examples of the computer readable medium include read-only memory, random-access memory, CD-ROMs, DVDs, magnetic tape, optical data storage devices, and carrier waves. The computer readable medium can also be distributed over network-coupled computer systems so that the computer readable code is stored and executed in a distributed fashion.

It will be appreciated that various above-disclosed embodiments, other features and functions, or alternatives thereof, may be desirably combined into many other different systems or applications. Various presently unforeseen or unanticipated alternatives, modifications, variations, or improvements therein may be subsequently made by those skilled in the art which are also intended to be encompassed by the following claims.

The following is claimed:

1. A method of facilitating anonymous placement of an order at a restaurant, the method comprising:
a. receiving at least one message from a user device, wherein the at least one message comprises the order;
b. transforming the at least one message into a structured order;
c. presenting at least one code to a user;
d. receiving the at least one code from the user;
e. presenting the order to the user, wherein the presentation is performed on the user device; and
f. performing at least one action on the at least one message based on receipt of each of the at least one code and confirmation of the order from the user.

2. The method of claim 1, wherein the at least one action comprises forwarding the at least one message to an order-taker device of the restaurant.

3. The method of claim 1, wherein performing the at least one action is based further on at least one predetermined rule.

4. The method of claim 1, wherein the at least one action comprises filtering the at least one message in order to remove at least one of unwanted language and an unnecessary word.

5. The method of claim 1, wherein transforming the at least one message into a structured order is based on at least one of text processing and speech processing.

6. The method of claim 5 further comprising:
a. comparing a portion of the at least one message with at least one data element of a menu associated with the restaurant; and
b. generating the structured order based on a result of the comparing.

7. The method of claim 1, wherein the presenting of the at least one code is performed at a location of the restaurant, wherein the location comprises at least one of at least one drive through lane, at least one intercom station, an interior of the restaurant and at least one order station.

8. The method of claim 7, wherein the at least one code is presented when the user is at a predetermined location in the at least one drive through lane, wherein the predetermined location is proximal to the intercom station.

9. The method of claim 1, wherein the presenting is performed on at least one of the user device and a presentation device associated with the restaurant.

10. The method of claim 1, wherein the receiving of the at least one code from the user comprises receiving a transmission from the user device, wherein the transmission comprises the at least one code.

11. The method of claim 1, wherein the receiving of the at least one code from the user comprises receiving a speech input from the user through an intercom station associated with the restaurant, wherein the speech input comprises the at least one code.

12. The method of claim 1, wherein the at least one message is at least one of a Short Service Message (SMS), an e-mail and an internet based message.

13. A system for facilitating anonymous placement of an order at a restaurant, the system comprising a communication unit configured to communicate with a user device associated with a user and a processor communicatively coupled to the communication unit, wherein the processor is configured to:
a. receive at least one message from the user device, wherein the at least one message comprises the order;
b. transform the at least one message into a structured order;
c. present at least one code to a user;
d. receive the at least one code from the user;
e. present the order to the user, wherein the presentation is performed on the user device; and
f. perform at least one action on the at least one message based on receipt of the at least one code.

14. The system of claim 13, wherein the at least one action comprises forwarding the at least one message to an order-taker device of the restaurant.

15. The system of claim 13, wherein performance of the at least one action is based further on at least one predetermined rule.

16. The system of claim 13, wherein the at least one action comprises filtering the at least one message in order to remove at least one of unwanted language and an unnecessary word.

17. The system of claim 13, wherein the processor is configured to transform the at least one message into a structured order based on at least one of text processing and speech processing.

18. The system of claim 17, wherein the processor is further configured to:
a. compare a portion of the at least one message with at least one data element of a menu associated with the restaurant; and
b. generate the structured order based on a result of the comparison.

19. The system of claim 13, wherein the presentation of the at least one code is performed at a location of the restaurant, wherein the location comprises at least one of at least one drive through lane, at least one intercom station, an interior of the restaurant and at least one order station.

20. The system of claim 19, wherein the at least one code is presented when the user is at a predetermined location in the at least one drive through lane, wherein the predetermined location is proximal to the intercom station.

21. The system of claim 13 further comprising a presentation device associated with the restaurant, wherein the presentation is performed on at least one of the user device and the presentation device.

22. The system of claim 13, wherein the reception of the at least one code from the user comprises reception of a transmission from the user device, wherein the transmission comprises the at least one code.

23. The system of claim 13, wherein the reception of the at least one code from the user comprises reception of a speech input from the user through an intercom station associated with the restaurant, wherein the speech input comprises the at least one code.

24. The system of claim 13, wherein the at least one message is at least one of a Short Service Message (SMS), an e-mail and an internet based message.
